(19) United States
(12) Patent Application Publication
(10) Pub. No.: US 2006/0233258 A1
(43) Pub. Date: Oct. 19, 2006

(54) Scalable motion estimation

(75) Inventor: Thomas W. Holcomb, Bothell, WA (US)

Correspondence Address: KLARQUIST SPARKMAN LLP, 121 S.W. SALMON STREET, SUITE 1600, PORTLAND, OR, 97204, US

(73) Assignee: Microsoft Corporation, Redmond, WA (US)

(21) Appl. No.: 11/107,436

(22) Filed: Apr. 15, 2005

(51) Int. Cl. H04N 11/02; H04N 11/04; H04N 7/12; H04B 1/66

(52) U.S. Cl. 375/240.21; 375/240.12; 375/240.24

(57) ABSTRACT

A number of features allow scaling complexity of motion estimation. These features are used alone or in combination with other features. A variable number of search seeds in a downsampled domain are searched in a reference frame dependent upon desirable complexity. A zero motion threshold value eliminates some searches in a downsampled domain. A ratio threshold value reduces the number of search seeds from a downsampled domain that would otherwise be used in an upsampled domain. Seeds searched in an original domain are reduced as required by complexity. Various sub-pixel search configurations are described for varying complexity. These features provide scalable motion estimation for downsampled, original, or sub-pixel search domains.

### FIELD

The described technology relates to video compression, and more specifically, to motion estimation in video compression.

### COPYRIGHT AUTHORIZATION

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Digital video consumes large amounts of storage and transmission capacity. A typical raw digital video sequence includes 15 or 30 frames per second. Each frame can include tens or hundreds of thousands of pixels (also called pels). Each pixel represents a tiny element of the picture. In raw form, a computer commonly represents a pixel with 24 bits. Thus, the number of bits per second, or bit rate, of a typical raw digital video sequence can be 5 million bits/second or more.

Most computers and computer networks lack the resources to process raw digital video. For this reason, engineers use compression (also called coding or encoding) to reduce the bit rate of digital video. Compression can be lossless, in which quality of the video does not suffer but decreases in bit rate are limited by the complexity of the video. Or, compression can be lossy, in which quality of the video suffers but decreases in bit rate are more dramatic. Decompression reverses compression.

In general, video compression techniques include intraframe compression and interframe compression. Intraframe compression techniques compress individual frames, typically called I-frames or key frames. Interframe compression techniques compress frames with reference to preceding and/or following frames, and are typically called predicted frames, P-frames, or B-frames.

For example, Microsoft Corporation's Windows Media Video, Version 8 [“WMV8”] includes a video encoder and a video decoder. The WMV8 encoder uses intraframe and interframe compression, and the WMV8 decoder uses intraframe and interframe decompression.

Intraframe Compression in WMV8

FIG. 1 illustrates a prior art block-based intraframe compression 100 of a block 105 of pixels in a key frame in the WMV8 encoder. A block is a set of pixels, for example, an 8×8 arrangement of samples for pixels (just pixels, for short). The WMV8 encoder splits a key video frame into 8×8 blocks and applies an 8×8 Discrete Cosine Transform [“DCT”] 110 to individual blocks such as the block 105. A DCT is a type of frequency transform that converts the 8×8 block of pixels (spatial information) into an 8×8 block of DCT coefficients 115, which are frequency information. The DCT operation itself is lossless or nearly lossless. Compared to the original pixel values, however, the DCT coefficients are more efficient for the encoder to compress since most of the significant information is concentrated in low frequency coefficients (conventionally, the upper left of the block 115) and many of the high frequency coefficients (conventionally, the lower right of the block 115) have values of zero or close to zero.

The encoder then quantizes 120 the DCT coefficients, resulting in an 8×8 block of quantized DCT coefficients 125. For example, the encoder applies a uniform, scalar quantization step size to each coefficient. Quantization is lossy. Since low frequency DCT coefficients tend to have higher values, quantization results in loss of precision but not complete loss of the information for the coefficients. On the other hand, since high frequency DCT coefficients tend to have values of zero or close to zero, quantization of the high frequency coefficients typically results in contiguous regions of zero values. In addition, in some cases high frequency DCT coefficients are quantized more coarsely than low frequency DCT coefficients, resulting in greater loss of precision/information for the high frequency DCT coefficients.

The encoder then prepares the 8×8 block of quantized DCT coefficients 125 for entropy encoding, which is a form of lossless compression. The exact type of entropy encoding can vary depending on whether a coefficient is a DC coefficient (lowest frequency), an AC coefficient (other frequencies) in the top row or left column, or another AC coefficient.

The encoder encodes the DC coefficient 126 as a differential from the DC coefficient 136 of a neighboring 8×8 block, which is a previously encoded neighbor (e.g., top or left) of the block being encoded. (FIG. 1 shows a neighbor block 135 that is situated to the left of the block being encoded in the frame.) The encoder entropy encodes 140 the differential.

The entropy encoder can encode the left column or top row of AC coefficients as a differential from a corresponding column or row of the neighboring 8×8 block. FIG. 1 shows the left column 127 of AC coefficients encoded as a differential 147 from the left column 137 of the neighboring (to the left) block 135. The differential coding increases the chance that the differential coefficients have zero values. The remaining AC coefficients are from the block 125 of quantized DCT coefficients.

The encoder scans 150 the 8×8 block 145 of predicted, quantized AC DCT coefficients into a one-dimensional array 155 and then entropy encodes the scanned AC coefficients using a variation of run length coding 160. The encoder selects an entropy code from one or more run/level/last tables 165 and outputs the entropy code.

Interframe Compression in WMV8

Interframe compression in the WMV8 encoder uses block-based motion compensated prediction coding followed by transform coding of the residual error. FIGS. 2 and 3 illustrate the block-based interframe compression for a predicted frame in the WMV8 encoder. In particular, FIG. 2 illustrates motion estimation for a predicted frame 210 and FIG. 3 illustrates compression of a prediction residual for a motion-estimated block of a predicted frame.

For example, the WMV8 encoder splits a predicted frame into 8×8 blocks of pixels. Groups of four 8×8 blocks form macroblocks. For each macroblock, a motion estimation process is performed. The motion estimation approximates the motion of the macroblock of pixels relative to a reference frame, for example, a previously coded, preceding frame. In FIG. 2, the WMV8 encoder computes a motion vector for a macroblock 215 in the predicted frame 210. To compute the motion vector, the encoder searches in a search area 235 of a reference frame 230. Within the search area 235, the encoder compares the macroblock 215 from the predicted frame 210 to various candidate macroblocks in order to find a candidate macroblock that is a good match. Various prior art motion estimation techniques are described in U.S. Pat. No. 6,418,166. After the encoder finds a good matching macroblock, the encoder outputs information specifying the motion vector (entropy coded) for the matching macroblock so the decoder can find the matching macroblock during decoding. When decoding the predicted frame 210 with motion compensation, a decoder uses the motion vector to compute a prediction macroblock for the macroblock 215 using information from the reference frame 230. The prediction for the macroblock 215 is rarely perfect, so the encoder usually encodes 8×8 blocks of pixel differences (also called the error or residual blocks) between the prediction macroblock and the macroblock 215 itself.

FIG. 3 illustrates an example of computation and encoding of an error block 335 in the WMV8 encoder. The error block 335 is the difference between the predicted block 315 and the original current block 325. The encoder applies a DCT 340 to the error block 335, resulting in an 8×8 block 345 of coefficients. The encoder then quantizes 350 the DCT coefficients, resulting in an 8×8 block of quantized DCT coefficients 355. The quantization step size is adjustable. Quantization results in loss of precision, but not complete loss of the information for the coefficients.

The encoder then prepares the 8×8 block 355 of quantized DCT coefficients for entropy encoding. The encoder scans 360 the 8×8 block 355 into a one-dimensional array 365 with 64 elements, such that coefficients are generally ordered from lowest frequency to highest frequency, which typically creates long runs of zero values.

The encoder entropy encodes the scanned coefficients using a variation of run length coding 370. The encoder selects an entropy code from one or more run/level/last tables 375 and outputs the entropy code.

FIG. 4 shows an example of a corresponding decoding process 400 for an inter-coded block. Due to the quantization of the DCT coefficients, the reconstructed block 475 is not identical to the corresponding original block. The compression is lossy.

In summary of FIG. 4, a decoder decodes (410, 420) entropy-coded information representing a prediction residual using variable length decoding 410 with one or more run/level/last tables 415 and run length decoding 420. The decoder inverse scans 430 a one-dimensional array 425 storing the entropy-decoded information into a two-dimensional block 435. The decoder inverse quantizes and inverse discrete cosine transforms (together, 440) the data, resulting in a reconstructed error block 445. In a separate motion compensation path, the decoder computes a predicted block 465 using motion vector information 455 for displacement from a reference frame. The decoder combines 470 the predicted block 465 with the reconstructed error block 445 to form the reconstructed block 475.

The amount of change between the original and reconstructed frame is termed the distortion and the number of bits required to code the frame is termed the rate for the frame. The amount of distortion is roughly inversely proportional to the rate. In other words, coding a frame with fewer bits (greater compression) will result in greater distortion, and vice versa.

Bi-Directional Prediction

Bi-directionally coded images (e.g., B-frames) use two images from the source video as reference (or anchor) images. For example, referring to FIG. 5, a B-frame 510 in a video sequence has a temporally previous reference frame 520 and a temporally future reference frame 530.

Some conventional encoders use five prediction modes (forward, backward, direct, interpolated and intra) to predict regions in a current B-frame. In intra mode, an encoder does not predict a macroblock from either reference image, and therefore calculates no motion vectors for the macroblock. In forward and backward modes, an encoder predicts a macroblock using either the previous or future reference frame, and therefore calculates one motion vector for the macroblock. In direct and interpolated modes, an encoder predicts a macroblock in a current frame using both reference frames. In interpolated mode, the encoder explicitly calculates two motion vectors for the macroblock. In direct mode, the encoder derives implied motion vectors by scaling the co-located motion vector in the future reference frame, and therefore does not explicitly calculate any motion vectors for the macroblock. Often, when discussing motion vectors, the reference frame is a source of the video information for prediction of the current frame, and a motion vector indicates where to place a block of video information from a reference frame into the current frame as a prediction (potentially then modified with residual information).

Motion estimation and compensation are very important to the efficiency of a video codec. The quality of prediction depends on which motion vectors are used, and it often has a major impact on the bit rate of compressed video. Finding good motion vectors, however, can consume an extremely large amount of encoder-side resources. While prior motion estimation tools use a wide variety of techniques to compute motion vectors, such prior motion estimation tools are typically optimized for one particular level of quality or type of encoder. The prior motion estimation tools fail to offer effective scalable motion estimation options for different quality levels, encoding speed levels, and/or encoder complexity levels.

Given the critical importance of video compression and decompression to digital video, it is not surprising that video compression and decompression are richly developed fields. Whatever the benefits of previous video compression and decompression techniques, however, they do not have the advantages of the following techniques and tools.

### SUMMARY

The described technologies provide methods and systems for scalable motion estimation. The following summary describes a few of the features described in the detailed description, but is not intended to summarize the technology.

Various combinations of one or more of the features provide motion estimation with varying complexity of estimation. In one example, the complexity of the motion estimation process is adaptable to variations of computational bounds. Although not required, complexity can be varied or adjusted based on the resources available in a given situation. In a real-time application, for example, the amount of processor cycles devoted to the search operation is less than in an application where quality is the main requirement and the speed of processing is less important.

In one example, a video encoder is adapted to perform scalable motion estimation according to values for plural scalability parameters, the plural scalability parameters including two or more of a first parameter indicating a seed count, a second parameter indicating a zero motion threshold, a third parameter indicating a fitness ratio threshold, a fourth parameter indicating an integer pixel search point count, or a fifth parameter indicating a sub-pixel search point count.

In another example, a number of features allow scaling complexity of motion estimation. These features are used alone or in combination with other features. A variable number of search seeds in a downsampled domain are searched and provided from a reference frame dependent upon desirable complexity. A zero motion threshold value eliminates some seeds from a downsampled domain. A ratio threshold value reduces the number of search seeds from a downsampled domain that would otherwise be used in an original domain. The area surrounding seeds searched in the original domain is reduced as required by complexity. Various sub-pixel search configurations are described for varying complexity. These features provide scalable motion estimation options for downsampled, original, or sub-pixel search domains.

In other examples a video encoder performs scalable motion estimation according to various methods and systems. A downsampling from an original domain to a downsampled domain is described before searching a reduced search area in the downsampled domain. Searching in the downsampled domain identifies one or more seeds representing the closest matching blocks. Upsampling the identified one or more seeds provides search seeds in the original domain. Searching blocks in the original domain, represented by the upsampled seeds, identifies one or more closest matching blocks at integer pixel offsets in the original domain. A gradient is determined between a closest matching block and a second closest matching block in the original domain. Sub-pixel offsets near the determined gradient represent blocks of interest in a sub-pixel domain search. Blocks of interpolated values are searched to provided a closest matching block of interpolated values.

Additional features and advantages will be made apparent from the following detailed description, which proceeds with reference to the accompanying drawings.

### BRIEF DESCRIPTION OF THE DRAWINGS

FIG. 1 is a diagram showing block-based intraframe compression of an 8×8 block of pixels according to the prior art.

FIG. 2 is a diagram showing motion estimation in a video encoder according to the prior art.

FIG. 3 is a diagram showing block-based interframe compression for an 8×8 block of prediction residuals in a video encoder according to the prior art.

FIG. 4 is a diagram showing block-based interframe decompression for an 8×8 block of prediction residuals in a video decoder according to the prior art.

FIG. 5 is a diagram showing a B-frame with past and future reference frames according to the prior art.

FIG. 6 is a block diagram of a suitable computing environment in which several described embodiments may be implemented.

FIG. 7 is a block diagram of a generalized video encoder system used in several described embodiments.

FIG. 8 is a block diagram of a generalized video decoder system used in several described embodiments.

FIG. 9 is a flow chart of an exemplary method of scalable motion estimation.

FIG. 10 is a diagram depicting an exemplary downsampling of video data from an original domain.

FIG. 11 is a diagram comparing integer pixel search complexity for two search patterns in the original domain.

FIG. 12 is a diagram depicting an exhaustive sub-pixel search in a half-pixel resolution.

FIG. 13 is a diagram depicting an exhaustive sub-pixel search in a quarter-pixel resolution.

FIG. 14 is a diagram depicting a three position sub-pixel search defined by a horizontal gradient in a half-pixel resolution.

FIGS. 15 and 16 are diagrams depicting three position half-pixel searches along vertical and diagonal gradients, respectively.

FIG. 17 is a diagram depicting a four position sub-pixel searched defined by a horizontal gradient in a quarter-pixel resolution.

FIGS. 18 and 19 are diagrams depicting four position sub-pixel searches defined by vertical and diagonal gradients in a quarter-pixel resolution, respectively.

FIG. 20 is a diagram depicting an eight position sub-pixel searched defined by a horizontal gradient in a quarter-pixel resolution.

FIGS. 21 and 22 are diagrams depicting eight position sub-pixel searches defined by vertical and diagonal gradients in a quarter-pixel resolution, respectively.

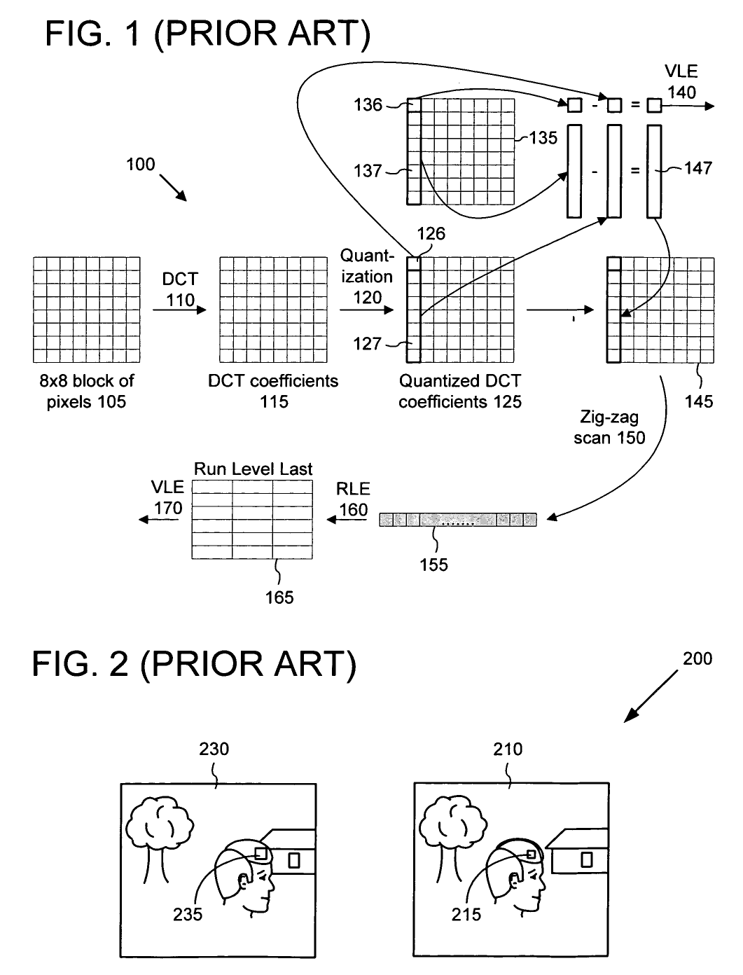

### DETAILED DESCRIPTION

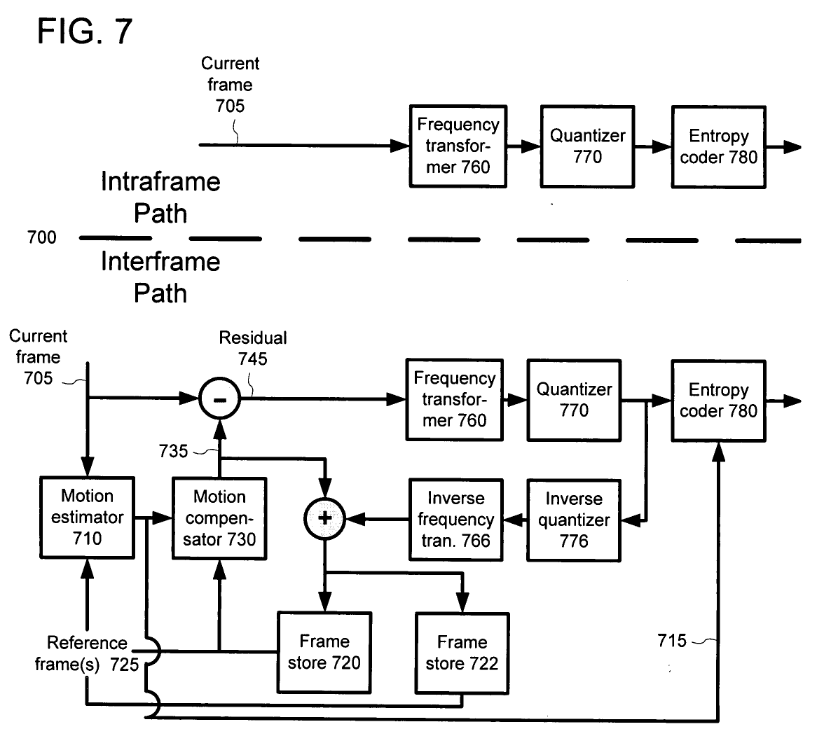

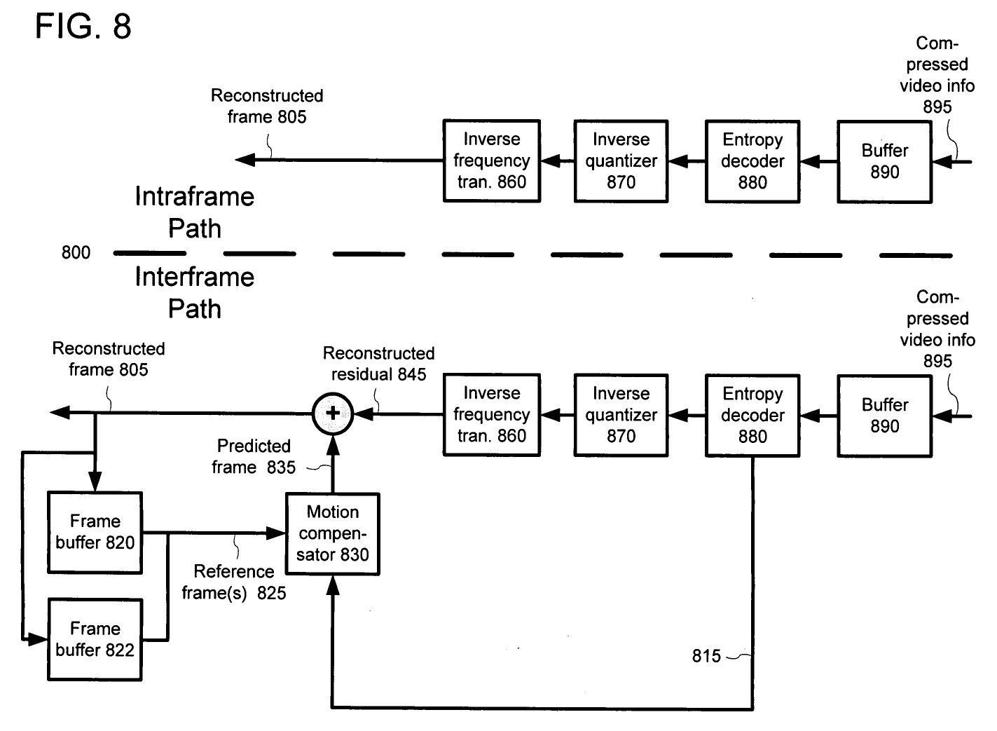

For purposes of illustration, the various aspects of the innovations described herein are incorporated into or used by embodiments of a video encoder and decoder (codec) illustrated in FIGS. 7-8. In alternative embodiments, the innovations described herein can be implemented independently or in combination in the context of other digital signal compression systems, and implementations may produce motion vector information in compliance with any of various video codec standards. In general, the innovations described herein can be implemented in a computing device, such as illustrated in FIG. 6. Additionally, a video encoder incorporating the described innovations or a decoder utilizing an output created utilizing the described innovations can be implemented in various combinations of software and/or in dedicated or programmable digital signal processing hardware in other digital signal processing devices.

### Exemplary Computing Environment

FIG. 6 illustrates a generalized example of a suitable computing environment 600 in which several of the described embodiments may be implemented. The computing environment 600 is not intended to suggest any limitation as to scope of use or functionality, as the techniques and tools may be implemented in diverse general-purpose or special-purpose computing environments.

With reference to FIG. 6, the computing environment 600 includes at least one processing unit 610 and memory 620. In FIG. 6, this most basic configuration 630 is included within a dashed line. The processing unit 610 executes computer-executable instructions and may be a real or a virtual processor. In a multi-processing system, multiple processing units execute computer-executable instructions to increase processing power. The memory 620 may be volatile memory (e.g., registers, cache, RAM), non-volatile memory (e.g., ROM, EEPROM, flash memory, etc.), or some combination of the two. The memory 620 stores software 680 implementing a video encoder (with scalable motion estimation options) or decoder.

A computing environment may have additional features. For example, the computing environment 600 includes storage 640, one or more input devices 650, one or more output devices 660, and one or more communication connections 670. An interconnection mechanism (not shown) such as a bus, controller, or network interconnects the components of the computing environment 600. Typically, operating system software (not shown) provides an operating environment for other software executing in the computing environment 600, and coordinates activities of the components of the computing environment 600.

The storage 640 may be removable or non-removable, and includes magnetic disks, magnetic tapes or cassettes, CD-ROMs, DVDs, or any other medium which can be used to store information and which can be accessed within the computing environment 600. The storage 640 stores instructions for the software 680 implementing the video encoder or decoder.

The input device(s) 650 may be a touch input device such as a keyboard, mouse, pen, or trackball, a voice input device, a scanning device, or another device that provides input to the computing environment 600. For audio or video encoding, the input device(s) 650 may be a sound card, video card, TV tuner card, or similar device that accepts audio or video input in analog or digital form, or a CD-ROM or CD-RW that reads audio or video samples into the computing environment 600. The output device(s) 660 may be a display, printer, speaker, CD-writer, or another device that provides output from the computing environment 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The techniques and tools can be described in the general context of computer-readable media. Computer-readable media are any available media that can be accessed within a computing environment. By way of example, and not limitation, with the computing environment 600, computer-readable media include memory 620, storage 640, communication media, and combinations of any of the above. The techniques and tools can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types.

The functionality of the program modules may be combined or split between program modules as desired in various embodiments. Computer-executable instructions for program modules may be executed within a local or distributed computing environment.

For the sake of presentation, the detailed description uses terms like “indicate,” “choose,” “obtain,” and “apply” to describe computer operations in a computing environment. These terms are high-level abstractions for operations performed by a computer, and should not be confused with acts performed by a human being. The actual computer operations corresponding to these terms vary depending on implementation.

### Exemplary Video Encoder and Decoder

FIG. 7 is a block diagram of a generalized video encoder 700 and FIG. 8 is a block diagram of a generalized video decoder 800.

The relationships shown between modules within the encoder and decoder indicate the main flow of information in the encoder and decoder; other relationships are not shown for the sake of simplicity. In particular, unless indicated otherwise, FIGS. 7 and 8 generally do not show side information indicating the encoder settings, modes, tables, etc. used for a video sequence, frame, macroblock, block, etc. Such side information is sent in the output bit stream, typically after entropy encoding of the side information. The format of the output bit stream can be a Windows Media Video format, VC-1 format, H.264/AVC format, or another format.

The encoder 700 and decoder 800 are block-based and use a 4:2:0 macroblock format. Each macroblock includes four 8×8 luminance blocks (at times treated as one 16×16 macroblock) and two 8×8 chrominance blocks. The encoder 700 and decoder 800 also can use a 4:1:1 macroblock format with each macroblock including four 8×8 luminance blocks and four 4×8 chrominance blocks. FIGS. 7 and 8 show processing of video frames. More generally, the techniques described herein are applicable to video pictures, including progressive frames, interlaced fields, or frames that include a mix of progressive and interlaced content. Alternatively, the encoder 700 and decoder 800 are object-based, use a different macroblock or block format, or perform operations on sets of pixels of different size or configuration.

Depending on implementation and the type of compression desired, modules of the encoder or decoder can be added, omitted, split into multiple modules, combined with other modules, and/or replaced with like modules. In alternative embodiments, encoder or decoders with different modules and/or other configurations of modules perform one or more of the described techniques.

FIG. 7 is a block diagram of a general video encoder system 700. The encoder system 700 receives a sequence of video frames including a current frame 705, and produces compressed video information 795 as output. Particular embodiments of video encoders typically use a variation or supplemented version of the generalized encoder 700.

The encoder system 700 compresses predicted frames and key frames. For the sake of presentation, FIG. 7 shows a path for key frames through the encoder system 700 and a path for predicted frames. Many of the components of the encoder system 700 are used for compressing both key frames and predicted frames. The exact operations performed by those components can vary depending on the type of information being compressed.

A predicted frame (also called P-frame, B-frame, or inter-coded frame) is represented in terms of prediction (or difference) from one or more reference (or anchor) frames. A prediction residual is the difference between what was predicted and the original frame. In contrast, a key frame (also called I-frame, intra-coded frame) is compressed without reference to other frames.

If the current frame 705 is a forward-predicted frame, a motion estimator 710 estimates motion of macroblocks or other sets of pixels of the current frame 705 with respect to a reference frame, which is the reconstructed previous frame 725 buffered in a frame store (e.g., frame store 720). If the current frame 705 is a bi-directionally-predicted frame (a B-frame), a motion estimator 710 estimates motion in the current frame 705 with respect to two reconstructed reference frames. Typically, a motion estimator estimates motion in a B-frame with respect to a temporally previous reference frame and a temporally future reference frame. Accordingly, the encoder system 700 can comprise separate stores 720 and 722 for backward and forward reference frames. Various techniques are described herein for providing scalable motion estimation.

The motion estimator 710 can estimate motion by pixel, ½ pixel, ¼ pixel, or other increments, and can switch the resolution of the motion estimation on a frame-by-frame basis or other basis. The resolution of the motion estimation can be the same or different horizontally and vertically. The motion estimator 710 outputs as side information motion information 715 such as motion vectors. A motion compensator 730 applies the motion information 715 to the reconstructed frame(s) 725 to form a motion-compensated current frame 735. The prediction is rarely perfect, however, and the difference between the motion-compensated current frame 735 and the original current frame 705 is the prediction residual 745.

A frequency transformer 760 converts the spatial domain video information into frequency domain (i.e., spectral) data. For block-based video frames, the frequency transformer 760 applies a discrete cosine transform [“DCT”] or variant of DCT to blocks of the pixel data or prediction residual data, producing blocks of DCT coefficients. Alternatively, the frequency transformer 760 applies another conventional frequency transform such as a Fourier transform or uses wavelet or subband analysis. In some embodiments, the frequency transformer 760 applies an 8×8, 8×4, 4×8, or other size frequency transforms (e.g., DCT) to prediction residuals for predicted frames. A quantizer 770 then quantizes the blocks of spectral data coefficients.

When a reconstructed current frame is needed for subsequent motion estimation/compensation, an inverse quantizer 776 performs inverse quantization on the quantized spectral data coefficients. An inverse frequency transformer 766 then performs the inverse of the operations of the frequency transformer 760, producing a reconstructed prediction residual (for a predicted frame) or a reconstructed key frame.

If the current frame 705 was a key frame, the reconstructed key frame is taken as the reconstructed current frame (not shown). If the current frame 705 was a predicted frame, the reconstructed prediction residual is added to the motion-compensated current frame 735 to form the reconstructed current frame. If desirable, a frame store (e.g., frame store 720) buffers the reconstructed current frame for use in predicting another frame. In some embodiments, the encoder applies a deblocking filter to the reconstructed frame to adaptively smooth discontinuities in the blocks of the frame.

The entropy coder 780 compresses the output of the quantizer 770 as well as certain side information (e.g., motion information 715, spatial extrapolation modes, quantization step size). Typical entropy coding techniques include arithmetic coding, differential coding, Huffman coding, run length coding, LZ coding, dictionary coding, and combinations of the above. The entropy coder 780 typically uses different coding techniques for different kinds of information (e.g., DC coefficients, AC coefficients, different kinds of side information), and can choose from among multiple code tables within a particular coding technique.

The entropy coder 780 puts compressed video information 795 in the buffer 790. A buffer level indicator is fed back to bit rate adaptive modules.

The compressed video information 795 is depleted from the buffer 790 at a constant or relatively constant bit rate and stored for subsequent streaming at that bit rate. Therefore, the level of the buffer 790 is primarily a function of the entropy of the filtered, quantized video information, which affects the efficiency of the entropy coding. Alternatively, the encoder system 700 streams compressed video information immediately following compression, and the level of the buffer 790 also depends on the rate at which information is depleted from the buffer 790 for transmission.

Before or after the buffer 790, the compressed video information 795 can be channel coded for transmission over the network. The channel coding can apply error detection and correction data to the compressed video information 795.

FIG. 8 is a block diagram of a general video decoder system 800. The decoder system 800 receives information 895 for a compressed sequence of video frames and produces output including a reconstructed frame 805. Particular embodiments of video decoders typically use a variation or supplemented version of the generalized decoder 800.

The decoder system 800 decompresses predicted frames and key frames. For the sake of presentation, FIG. 8 shows a path for key frames through the decoder system 800 and a path for predicted frames. Many of the components of the decoder system 800 are used for decompressing both key frames and predicted frames. The exact operations performed by those components can vary depending on the type of information being decompressed.

A buffer 890 receives the information 895 for the compressed video sequence and makes the received information available to the entropy decoder 880. The buffer 890 typically receives the information at a rate that is fairly constant over time, and includes a jitter buffer to smooth short-term variations in bandwidth or transmission. The buffer 890 can include a playback buffer and other buffers as well. Alternatively, the buffer 890 receives information at a varying rate. Before or after the buffer 890, the compressed video information can be channel decoded and processed for error detection and correction.

The entropy decoder 880 entropy decodes entropy-coded quantized data as well as entropy-coded side information (e.g., motion information 815, spatial extrapolation modes, quantization step size), typically applying the inverse of the entropy encoding performed in the encoder. Entropy decoding techniques include arithmetic decoding, differential decoding, Huffman decoding, run length decoding, LZ decoding, dictionary decoding, and combinations of the above. The entropy decoder 880 frequently uses different decoding techniques for different kinds of information (e.g., DC coefficients, AC coefficients, different kinds of side information), and can choose from among multiple code tables within a particular decoding technique.

A motion compensator 830 applies motion information 815 to one or more reference frames 825 to form a prediction 835 of the frame 805 being reconstructed. For example, the motion compensator 830 uses a macroblock motion vector to find a macroblock in a reference frame 825. A frame buffer (e.g., frame buffer 820) stores previously reconstructed frames for use as reference frames. Typically, B-frames have more than one reference frame (e.g., a temporally previous reference frame and a temporally future reference frame). Accordingly, the decoder system 800 can comprise separate frame buffers 820 and 822 for backward and forward reference frames.

The motion compensator 830 can compensate for motion at pixel, ½ pixel, ¼ pixel, or other increments, and can switch the resolution of the motion compensation on a frame-by-frame basis or other basis. The resolution of the motion compensation can be the same or different horizontally and vertically. Alternatively, a motion compensator applies another type of motion compensation. The prediction by the motion compensator is rarely perfect, so the decoder 800 also reconstructs prediction residuals.

When the decoder needs a reconstructed frame for subsequent motion compensation, a frame buffer (e.g., frame buffer 820) buffers the reconstructed frame for use in predicting another frame. In some embodiments, the decoder applies a deblocking filter to the reconstructed frame to adaptively smooth discontinuities in the blocks of the frame.

An inverse quantizer 870 inverse quantizes entropy-decoded data. In general, the inverse quantizer applies uniform, scalar inverse quantization to the entropy-decoded data with a step-size that varies on a frame-by-frame basis or other basis. Alternatively, the inverse quantizer applies another type of inverse quantization to the data, for example, a non-uniform, vector, or non-adaptive quantization, or directly inverse quantizes spatial domain data in a decoder system that does not use inverse frequency transformations.

An inverse frequency transformer 860 converts the quantized, frequency domain data into spatial domain video information. For block-based video frames, the inverse frequency transformer 860 applies an inverse DCT [“IDCT”] or variant of IDCT to blocks of the DCT coefficients, producing pixel data or prediction residual data for key frames or predicted frames, respectively. Alternatively, the frequency transformer 860 applies another conventional inverse frequency transform such as a Fourier transform or uses wavelet or subband synthesis. In some embodiments, the inverse frequency transformer 860 applies an 8×8, 8×4, 4×8, or other size inverse frequency transforms (e.g., IDCT) to prediction residuals for predicted frames.

### Exemplary Scalable Motion Estimation

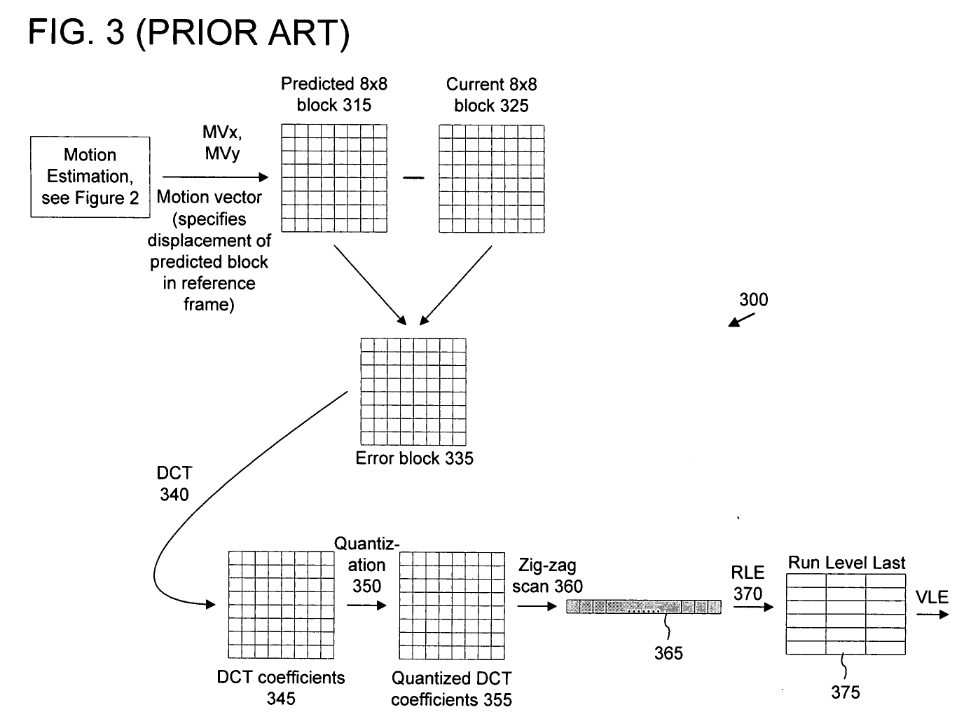

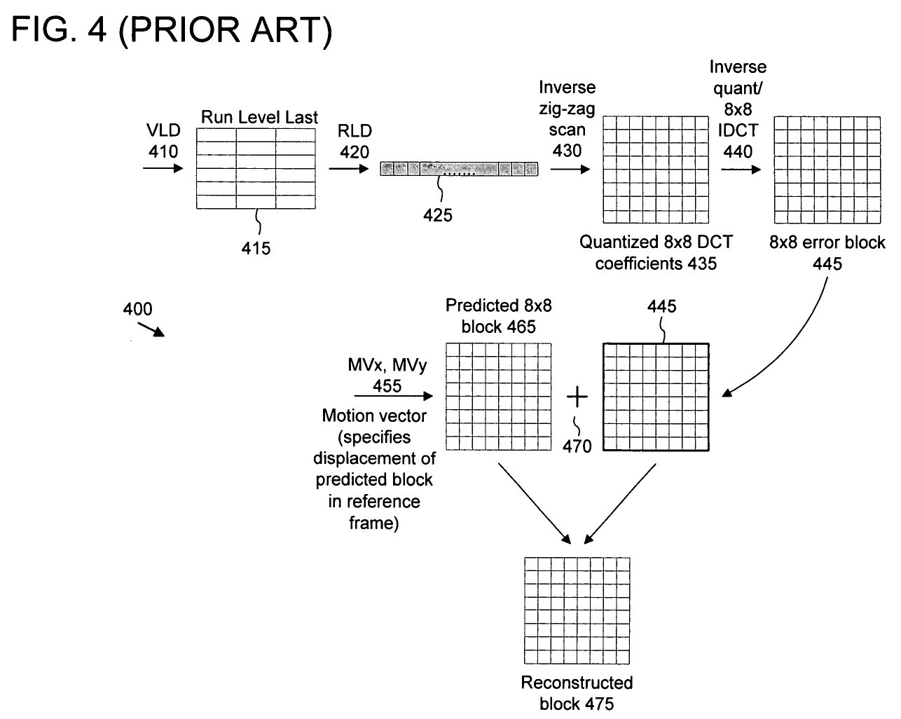

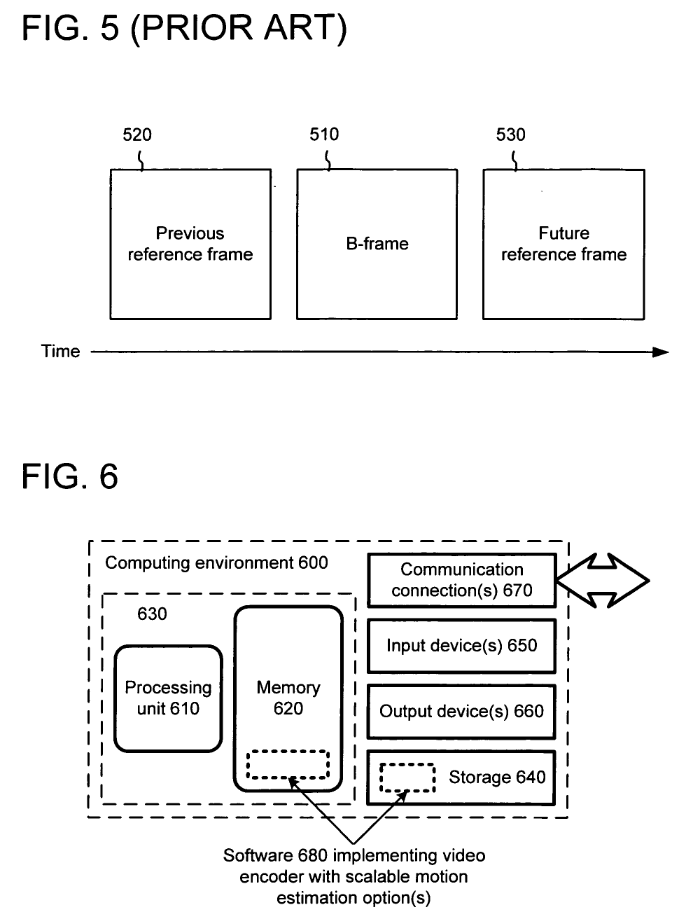

One aspect of high quality video compression is the effectiveness with which the motion estimator finds matching blocks in previously coded reference frames (e.g., see discussion of FIG. 2). Devoting more processing cycles to the search operation often achieves higher quality motion estimation but adds computational complexity in the encoder and increases the amount of processing time required for encoding.

Various combinations of one or more of the features described herein provide motion estimation at various complexity levels. The complexity of the motion estimation process adapts to variations in the computational bounds and/or encoding delay constraints, for example. Although not required, motion estimation complexity can be varied or adjusted based on the resources available in a given situation. In a real-time application, for example, the amount of processor cycles devoted to the search operation is less than in an application where quality is the main requirement and the speed of processing is less imperative. A number of features are described for scaling complexity of motion estimation. These features can be used alone or in combination. Such features comprise (1) a number of search seeds, (2) a zero motion threshold, (3) a ratio threshold, (4) a search range around seeds, and (5) a sub-pixel search configuration.

The values for these options in scalable motion estimation may depend on one or more user settings. For example, a user selects an encoding scenario, wizard profile, or other high-level description of an encoding path, and values associated with the scenario/profile/description are set for one or more of the number of search seeds, zero motion threshold, ratio threshold, search range around seeds, and sub-pixel search configuration. Or, the value for one or more of these options is directly set by a user through a user interface. Alternatively, one or more of these options has a value set when an encoder is installed in a computer system or device, depending on the system/device profile.

In another example, the complexity level is set adaptively by the encoder based on how much computational power is available. For example if the encoder is operating in realtime mode, the encoder measures how much CPU processing is being used by the compressor and adapts the complexity level up or down to try to achieve maximal performance within the computational ability.

These various features are used alone or in combination, to increase or decrease the complexity of motion estimation. Various aspects of these features are described throughout this disclosure. However, neither the titles of the features, nor the placement within paragraphs of the description of various aspects of features, are meant to limit how various aspects are used or combined with aspects of other features. After reading this disclosure, one of ordinary skill in the art will appreciate that the description proceeds with titles and examples in order to instruct the reader, and that once the concepts are grasped, aspects of the features are applied in practice with no such pedagogical limitations.

By varying the complexity of the search using one or more of the described features, motion estimation scalably operates within certain computational bounds. For example, for real-time applications, the number of processor cycles devoted to the search operation will generally be lower than for offline encoding. For this reason, a motion estimation scheme is scalable in terms of reducing complexity in order to adapt to computational bounds and/or encoding delay requirements. For applications where quality is the main requirement and total processing time is a minor factor then the motion estimation scheme is able to scale up in complexity and devote more processing cycles to the search operation in order to achieve high quality. For applications where meeting a strict time budget is the main requirement then the motion estimation process should be able to scale back in complexity in order to reduce the amount of processor cycles required. This invention provides an effective motion estimation that achieves high quality results at various complexity levels.

Motion compensated prediction may be applied to blocks of size 16 by 16 (16 samples wide by 16 lines) or 8 by 8 (8 samples wide by 8 lines), or to blocks of some other size. The process of finding the best match (according to some suitability criteria) for the current block in the reference frame is a very compute intensive process. There is a tradeoff between the thoroughness of the search and the amount of processing used in the search. The video compressors (e.g., coders) described herein are used in a wide variety of application areas ranging from low to high resolution video, and from real-time compressing (where performing the operations within a strict time frame is important) to offline compressing (where time is not a factor and high quality is the goal). It is for these reasons that a scalable motion estimation scheme provides value in terms of the ability to control or vary the amount of computation or complexity.

### Exemplary Motion Estimation Method

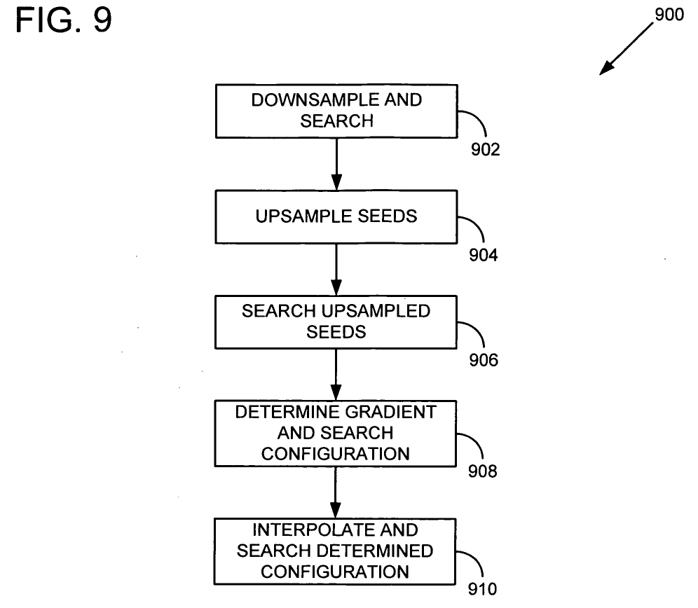

FIG. 9 is a flow chart of an exemplary method of scalable motion estimation. One aspect of motion estimation is to provide motion vectors for blocks in a predicted frame. A tool such as the video encoder 700 shown in FIG. 7 or another tool performs the method.

At 902, the tool downsamples a video frame to create a downsampled domain. For example, the vertical and horizontal pixel dimensions are downsampled by a factor of 2, 4, etc. The downsampled domain provides a more efficient high-level search environment since fewer samples need to be compared within a search area for a given original domain block size. The predicted frame and the reference frame are downsampled. The search area in the reference frame and the searched block sizes are reduced in proportion to the downsampling. The reduced blocks are compared to a specific reduced block in a downsampled predicted frame, and a number of closest matching blocks (according to some fitness measure) are identified within the reduced search area. The number of closest matching blocks (e.g., N), may be increased in applications with greater available computing resources. As N increases, it becomes more likely that the actual closest matching block will be identified in the next level search. Later, a ratio threshold value is described to reduce the number of seeds searched in the next level.

At 904, the tool upsamples motion vectors or other seed indicators for the closest matching blocks to identify corresponding candidate blocks in the original domain. For example, if a block's base pixel in the original domain is the pixel located at (32, 64), then in a 4:1 downsampled domain that block's base pixel is located at (8, 16). If a motion vector of (1, 1) is estimated for a seed at position (9, 17) in the downsampled domain, the upsample of the seed for the matching block at the (9, 17) location would be (36, 68). These upsampled seeds (and corresponding motion vectors) provide starting search locations for the search in the next level original domain.

At 906, the tool compares blocks (in the original domain) around the candidate blocks to a specific block in a predicted frame and identifies a closest matching block. For example, if a candidate block with seed located at (112, 179) is the closest matching block, then blocks with seeds within R integer pixels in any direction of the closest matching block are searched to see if they provide an even closer matching block. The number R will vary depending on the complexity of the desired search. The blocks around (within R integer pixels of) the candidate seeds are searched. Within all of the candidate block searches, a closest matching block to the current block is determined. After identifying the closest matching block, a next closest matching block is found within the seeds that are one pixel (R=1) offset from the closest matching block.

At 908, the tool determines a gradient between the locations of the closest matching block and the next closest matching block. The sub-pixel offsets near the closest matching block may represent an even better matching block. The sub-pixel search is focused based on a gradient between the closest and the next closest matching blocks. A sub-pixel search is configured according to the gradient (sub-pixel offsets near the gradient) and according to a scalable motion estimation complexity level. For example, if a high complexity level is desired, then a higher resolution sub-pixel domain is created (e.g., quarter-pixel) and more possible sub-pixel offsets around the gradient are searched to increase the probability of finding an even closer match.

At 910, the tool interpolates sub-pixel sample values for sub-pixel offsets in the sub-pixel search configuration, and compares blocks of interpolated values represented at sub-pixel offsets in the sub-pixel search configuration to the specific block in the current frame. The sub-pixel search determines whether any of the blocks of interpolated values at sub-pixel offsets provide a closer match. Later, various sub-pixel configurations are discussed in more detail.

### Exemplary Downsampled Search

A video frame can be represented with various sizes. In this example, the frame size is presented as 320 horizontal pixels by 240 rows of pixels. Although, a specific video frame size is used in this example, the described technologies are applicable to any frame size and picture type (e.g., frame, field).

Optionally, the video frame is downsampled by a factor of 4:1 in the horizontal and vertical dimensions. This reduces the reference frame from 320 by 240 pixels (e.g., original domain) to 80 by 60 pixels (e.g., the downsampled domain). Therefore, the frame size is reduced by a factor of 16. Additionally, the predicted frame is also downsampled by the same amount so comparisons remain proportional.

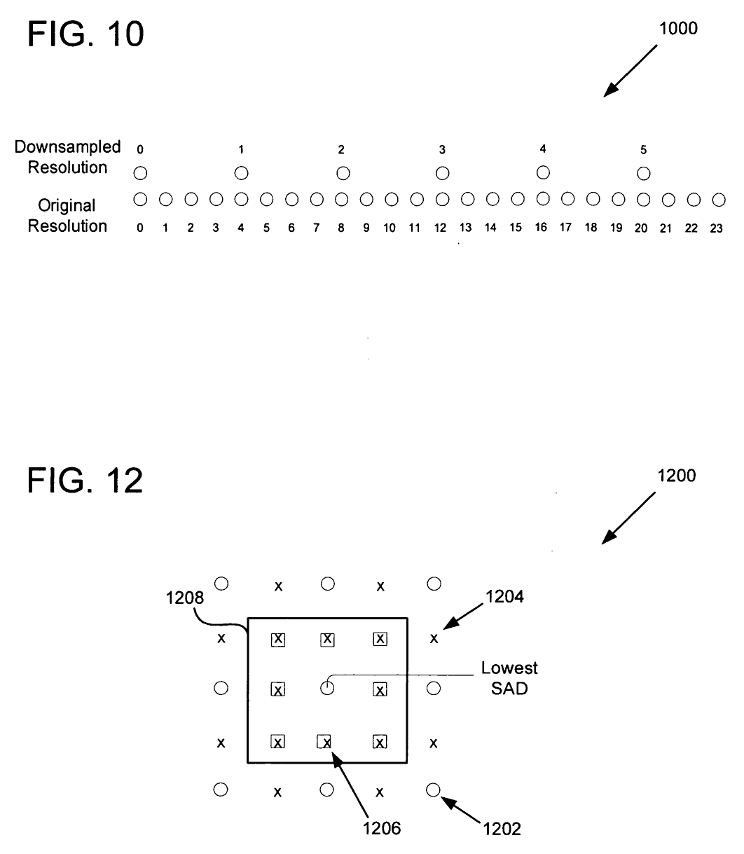

FIG. 10 is diagram depicting an exemplary downsampling of video data from an original domain. In this example, the correspondence 1000 between the samples in the downsampled domain and the samples in the original resolution domain is 4:1. Although the diagram 1000 shows samples only in the horizontal dimension, the vertical dimension is similarly downsampled.

Although not required, luminance data (brightness) is often represented as 8 bits per pixel. Although luminance data is used for comparison purposes in the search, chrominance data (color) may also be used in the search. Or, the video data may be represented in another color space (e.g., RGB), with the motion estimation performed for one or more color components in that color space. In this example, a search is performed in the downsampled domain, comparing a block or macroblock in the predicted (current) frame to find where the block moved in the search area of the reference frame.

To compute the motion vector, the encoder searches in a search area of a reference frame. Additionally, the search area and the size of a compared blocks or macroblocks are reduced by a factor of 16 (4:1 in horizontal and 4:1 in the vertical). The discussion proceeds while discussing both macroblock and blocks as “blocks” although either can be applied using the described techniques. Within the reduced search area, the encoder compares the reduced block from the current frame to various candidate reduced blocks in the reference frame in order to find candidate blocks that are a good match. Alternatively, since the relative size of the search area may be increased in the reference frame, the number of computation per candidate is typically reduced compared to searches in the original domain.

Thus, the 8×8 luminance block (or 16×16 luminance macroblock) that is being motion compensated is also downsampled by a factor of 4:1 in the vertical and horizontal dimensions. Therefore the comparisons are performed on blocks of size 2×2 and 4×4 in the downsampled domain.

The metric used to compare each block within the search area is sum of absolute differences (SAD) between the samples in the reference block and the samples in the block being coded (or predicted). Of course, other search criteria (such as mean squared error, actual encoded bits for residual information) can be used to compare differences on the luminance and/or chrominance data without departing from the described arrangement. The search criteria may incorporate other factors such as the actual or estimated number of bits used to represent motion vector information for a candidate, or the quantization factor expected for the candidate (which can affect both actual reconstructed quality and number of bits). These various types and combinations of search criteria, including SAD, are referred to as difference measures, fitness measures or block comparison methods, and are used to find the closest matching one or more compared blocks or macroblocks (where the “best” or “closest” match is a block among the blocks that are evaluated, which may only be a subset of the possibilities). For each block being coded using motion compensated prediction, a block comparison method is performed for all possible blocks or a subset of the blocks within a search area, or reduced search area.

For example, a search area of +63/−64 vertical samples and +31/−32 horizontal samples in the original domain is reduced to a search area of +15/−16 vertical samples and +7/−8 horizontal samples in the downsampled domain. This results in 512 fitness computations (32×16) in the downsampled domain as opposed to 1792 fitness computations in the original domain, if every spot in the search area is evaluated. If desirable, an area around the best fit (e.g., lowest SAD, lowest SAD+MV cost, or lowest weighted combination of SAD and MV cost) in the downsampled domain can be searched in the original domain. If so, the search area and size of blocks compared are increased by a factor of 16 to reflect the data in the original domain. Additionally, it is contemplated that the size of the downsample will vary from 4:1 (e.g., 2:1, 8:1, etc.) based upon various changing future conditions.

### Exemplary Number of Search Seeds

Optionally, instead of just obtaining the closest match block in the downsampled domain, multiple good candidates determined in the downsampled domain are reconsidered in the original domain. For example, an encoder is configured to select the best “N” match results for further consideration and search. For example, if N=3, an encoder would search for three blocks in the unsampled original domain that correspond with the N best match values (e.g., seed values) in the downsampled domain. The number of seeds N is used to trade off search quality for processing time. The greater the value of N the better the search result but the more processing required since the area around each seed is searched in the original domain.

Optionally, for a current block, the number of seeds obtained in a downsampled domain and used in the next level original domain search is also affected by various other parameters, such as a zero motion threshold or a ratio threshold.

### Exemplary Zero Motion Threshold

Optionally, the first position searched in the downsampled domain for a block is the zero displacement position. The zero displacement position (block) in the predicted frame is the block in the same position in the reference frame (motion vector of (0, 0). If the fitness measure (e.g., SAD) of the zero displacement block is less than or equal to a zero motion threshold in the reference frame, then no other searches are performed for that current block in the downsampled domain. A zero motion threshold can be represented in many ways, such as an absolute difference measure or estimated number of bits, depending on the fitness criteria used. For example, where the fitness measure relates to change in luminance values, if the luminance change between a downsampled zero displacement block in the reference frame and the downsampled block in the predicted frame is below the zero motion threshold, then a closest candidate has been found (given the zero motion threshold criteria) and no further search is necessary. Thus, the zero motion threshold indicates that, if very little luminance change has occurred between the blocks located in the same spatial position in the current and reference frames, then no further search is required in the downsampled domain.

In such an example, the zero displacement position can still be a seed position used in the original domain level search. The greater the value of zero motion threshold the more likely that the full downsampled search will not be performed for a block and therefore there will only be one seed value for the next level search, since the likelihood of the search proceeding decreases. The search complexity is expected to decrease with increasing values of zero motion threshold.

### Exemplary Ratio Threshold Value

Optionally, a ratio threshold operation is performed after all positions (or a subset of the positions) have been searched in the downsampled search area. For example, plural fitness metric (e.g., SAD) results are arranged in order from best to worst. Ratios of the adjacent metrics are compared to a ratio threshold in order to determine whether they will be searched in the next level original domain. In another example, only the N best metric seed results are arranged in order from best to worst. In either case, the ratios of the metrics are compared to determine if they are consistent with a ratio threshold value. A ratio threshold value performed on metric values in the downsampled domain can be used to limit search seeds further evaluated in the original resolution domain, either alone, or in combination with other features, such as a limit of N seeds.

For example, assume that an ordering of the N=5 lowest SADs for blocks in a search area are as follows: (4, 6, 8, 42, 48). The corresponding ratios of these adjacent ranked SAD values are as follows: (4/6, 6/8, 8/42, 42/48). If a ratio threshold value is set at a minimum value of 1/5, then only the first three seeds would be searched in the next level (original domain). Thus a ratio is used to throw out the last 2 potential seeds (those with SADs of 42 and 48) since the jump in SAD from 8 to 42 is too large according to the ratio threshold.

In another example, the ratio threshold value is combined with an absolute value requirement. For example, a ratio may not be applied to SADs of less than a certain absolute amount. For example, if the SAD is less than 10, then do not throw out the seed even if it fails in a ratio test. For example, an SAD jump from 1 to 6 would fail the above described ratio test, but the seed should be kept anyway since it is so low.

As shown in Table A, an operation is applied using two described features. For example, the operation includes a setting of “N” seeds with a ratio threshold value. As shown, the operation determines how many of the N possible seed values will be searched in the original domain:

TABLE A

n = 1
while (n < N && SAD[n]/SAD[n − 1] < RT)

n = n + 1

M = n

In this example, N limits the original domain search to the N lowest SADs found in the downsampled search. Potentially, all N seeds could next be searched in the original domain to determine the best fit (e.g., a lowest SAD) in the original domain. The SAD array is in order of least to greatest: SAD[0]<SAD[1]<SAD[2], etc. Additionally, in Table A, the while loop checks to see whether any SAD ratio violates the ratio threshold value (i.e., RT). The while loop ends when all ratios are checked, or when the RT value is violated, whichever occurs first. The output M is the number of seeds searched in the next level.

RT is the ratio threshold value and is a real valued positive number. The smaller the value of RT the more likely that the number of seeds used in the next level search will be less than N. The search complexity therefore decreases with decreasing values of RT. More generally, the scale of the ratio threshold depends on the fitness criteria used.

### Exemplary Search Range Around Seeds

As described above, the downsampled search provides seeds for an original domain search. For example, various ways of finding the best N seeds (according to some fitness metric and/or heuristic shortcuts) in a downsampled domain are described above. Additionally, a ratio threshold value limiting seeds is described above, and the N lowest seeds may be confirmed via a ratio threshold value as described above to provide M seeds. The seeds provide a reduced search set for the original domain.

If desirable, downsampled seed locations may serve as seed locations for a full resolution search in the original domain. If the downsampling factor was 4:1, the horizontal and vertical motion vector components for each seed position in the downsampled domain are multiplied by 4 to generate the starting position for (upsampled seeds) the search in the original domain. For example, if a downsampled motion vector is (2, 3) then the corresponding (upsampled) motion vector in the original resolution is (8, 12).

FIG. 10 is diagram depicting an exemplary downsampling of video data from an original domain. Upon returning to search in the original domain, the original data resolution is used for an original domain search. Additionally, the scope of the search in the original domain can scalably altered to provide plural complexity levels.

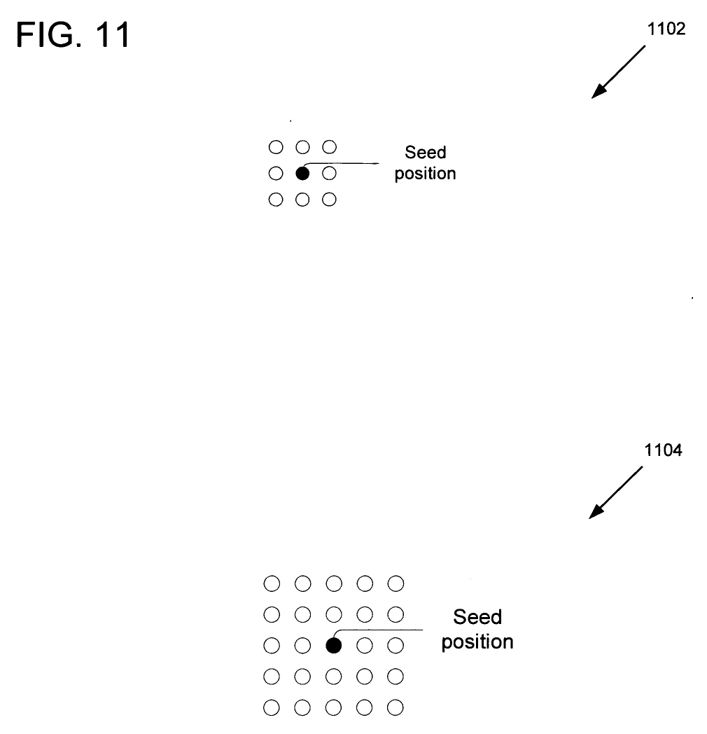

FIG. 11 is a diagram comparing integer pixel search complexity of video data in the original domain. For each of the one or more seeds (e.g., the N or M seeds) identified in the downsampled domain, a search is performed in the original resolution domain around the upsampled seed location. An upsampled seed represents a block (8×8) or macroblock (16×16) in the original domain (e.g., original domain block). As before, the upsampled seed describes a base position of a block or a macroblock used in fitness measure (e.g., SAD, SAD+MV cost, or some weighted combination of SAD and MV cost) computations.

The complexity of this search is governed by a value R which is the range of integer pixel positions (+/−R) that are searched around the upsampled seed positions. Although the R values may be further varied, presently there are two R values used, R=1 (+/−1) 1102 and R=2 (+/−2) 1104. A shown in FIG. 11, for R=1 a search of +/1 integer offset positions in the horizontal and vertical directions are searched around the seed location 1102. Therefore, 9 positions (e.g., 9 blocks or macroblocks) are searched. For R=2, a search of +/−2 integer offset positions in the horizontal and vertical directions are searched around the seed location 1104. Thus, for R=2, 25 positions (e.g., blocks or macroblocks) are searched. It is possible that the upsampled seed itself continues to be the best fit (e.g., lowest SAD) in the original domain. The search in the original domain 1102 or 1104 results in one position being chosen as the best integer pixel position per seed and overall. The best integer pixel position chosen is the one with the best fit (e.g., lowest SAD). The seed position identifies base positions for the upsampled candidate blocks compared.

### Exemplary Sub-pixel Search Points

In the previous paragraph, the search in the original domain 1102 or 1104 results in one position being chosen as the best integer pixel position. The best integer pixel position chosen is the one with the best fit (e.g., lowest SAD). The complexity of the sub-pixel search is determined by the number of searches performed around the best integer position. Based upon scalable computing conditions, the number of sub-pixel searches surrounding the best pixel location can be varied.

FIG. 12 is a diagram depicting an exhaustive sub-pixel search in a half-pixel resolution. As shown, the integer pixel locations are depicted as open circles 1202, and each of the interpolated values at half-pixel locations is depicted as an “X” 1204. A searched sub-pixel offset is indicated as an “X” enclosed in a box 1206. Thus, an exhaustive half-pixel search requires 8 sub-pixel fitness metric (e.g., SAD) computations, where each computation may involve a sample-by-sample comparison within the block. As with the downsampled domain and the original domain, a depicted sub-pixel offset describes a base position used to identify a block used in a fitness measure computation. Various methods are known for interpolating integer pixel data into sub-pixel data (e.g., bilinear interpolation, bicubic interpolation), and any of these methods can be employed for this purpose before motion estimation or concurrently with motion estimation.

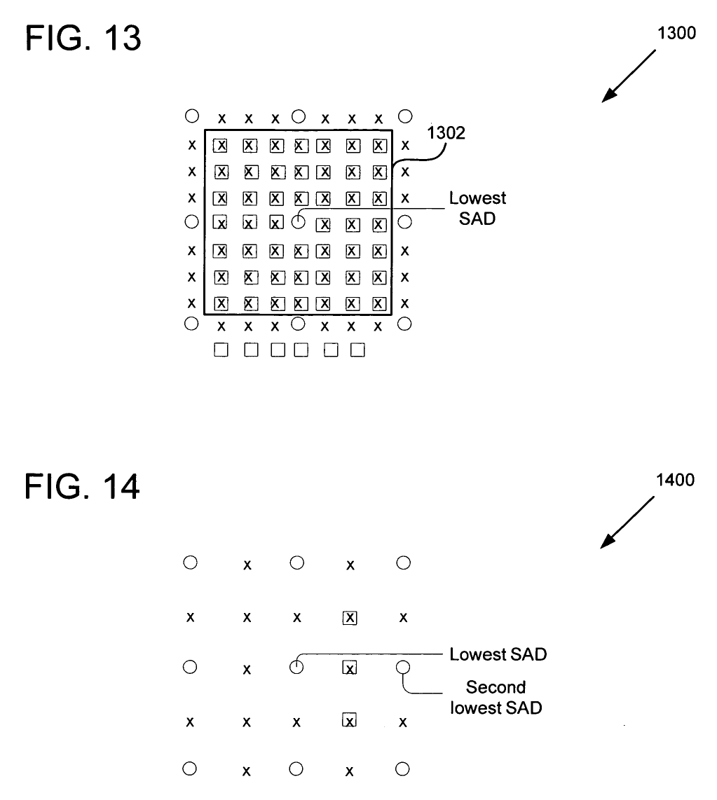

FIG. 13 is a diagram depicting an exhaustive sub-pixel search in a quarter-pixel resolution. In this example, integer pixels are interpolated into values at quarter-pixel resolution. As shown, an exhaustive search 1300 can be performed at the quarter-pixel offsets, with 48 fitness measure (e.g., SAD) computations. As shown, an exhaustive sub-pixel domain search involves performing SAD computations for all sub-pixel offsets reachable 1302, 1208 without reaching or passing an adjacent integer pixel.

Optionally, in the integer pixel original domain 1102, 1104, a second lowest integer pixel location is also chosen. A second lowest integer pixel location can be used to focus a sub-pixel search.

FIG. 14 is a diagram depicting a three position sub-pixel search defined by a horizontal gradient in a half-pixel resolution. A sub-pixel search is performed at pixels near the gradient. As shown, a SAD search in the integer pixel domain 1400 produces not only a lowest, but also a second lowest SAD. Although not shown, a gradient from the lowest SAD to the second lowest SAD helps focus a search on interpolated sub-pixel offsets closest to the gradient. As shown, three half-pixel offsets are searched in a half pixel resolution search. The interpolated value blocks represented by these three sub-pixel offsets are searched in order to determine if there is an even better fitness metric value (e.g., lower available SAD value). Of course, the purpose of further focusing the search to sub-pixel offsets, is to provide even better resolution for block movement, and more accurate motion vectors often available in the sub-pixel range. In this example, a three position search 1400 is conducted based on a horizontal gradient.

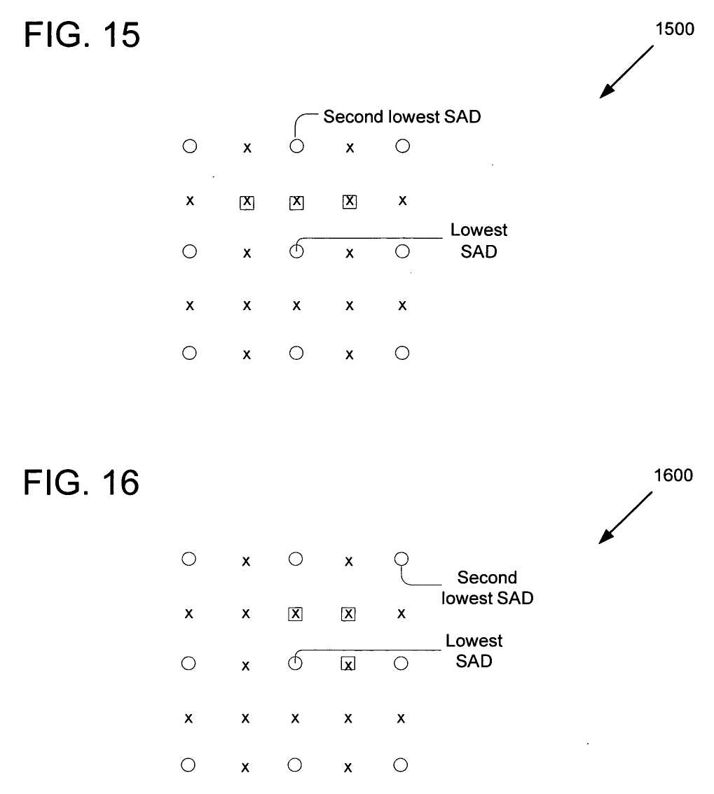

FIGS. 15 and 16 are diagrams depicting three position sub-pixel searches along vertical 1500 and diagonal gradients 1600. Again, the X's show all the half-pixel offset positions, the circles show the integer pixel positions and the squares show the sub-pixel offset positions that are searched.

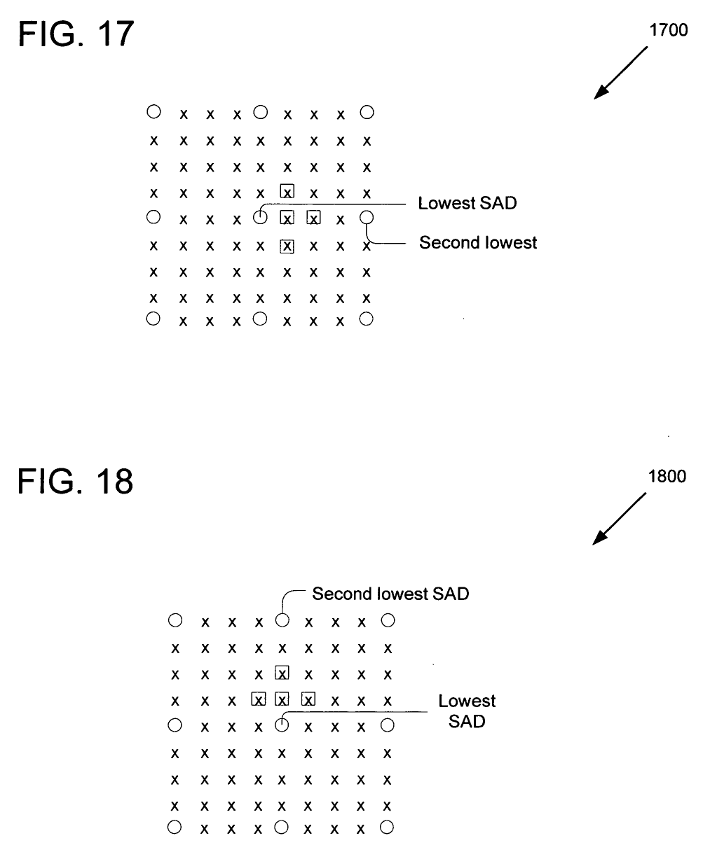

FIG. 17 is a diagram depicting a four position sub-pixel search 1700 defined by a horizontal gradient in a quarter-pixel resolution.

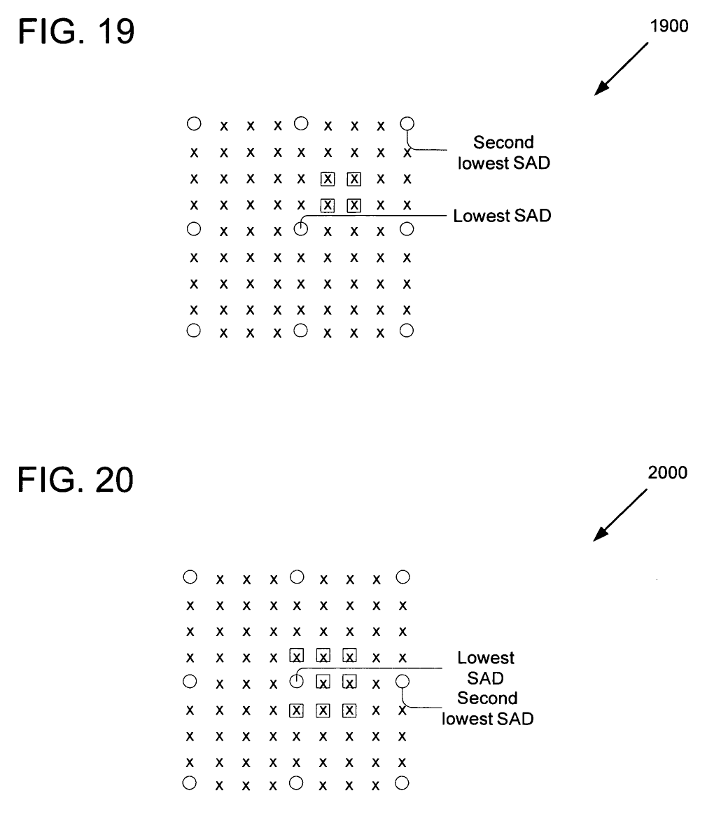

FIGS. 18 and 19 are diagrams depicting four position sub-pixel searches defined by vertical 1800 and diagonal 1900 gradients in a quarter-pixel resolution.

FIG. 20 is a diagram depicting an eight position sub-pixel search 2000 defined by a horizontal gradient in a quarter-pixel resolution.

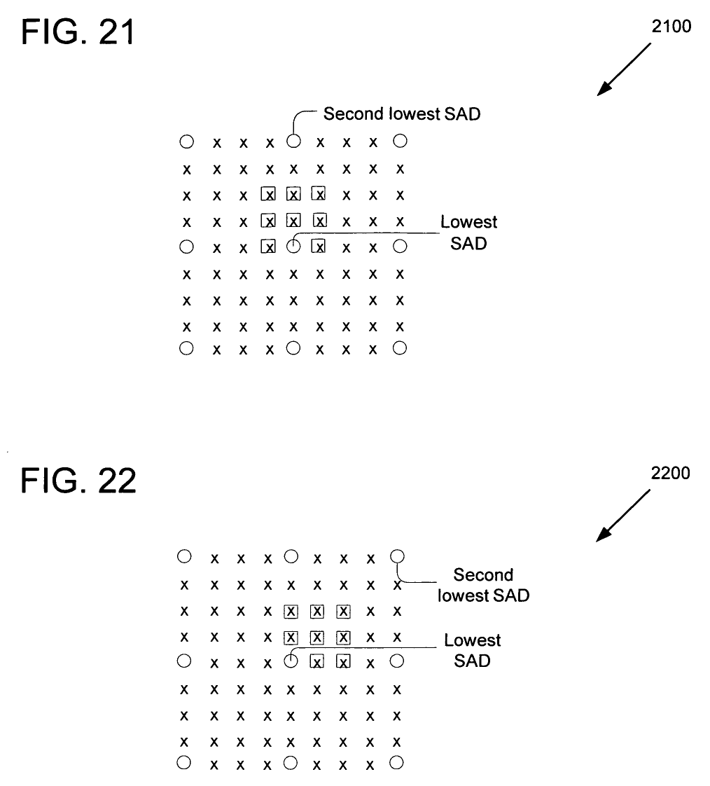

FIGS. 21 and 22 are diagrams depicting eight position sub-pixel searches defined by vertical 2100 and diagonal 2200 gradients in a quarter-pixel resolution.

The suggested search patterns and numbers of searches in the sub-pixel domain have provided interesting results. Although not shown, it is also contemplated that other patterns and numbers of searches of varying thoroughness in the sub-pixel domain can be performed. Additionally, the resolution of the sub-pixel domain (e.g., half, quarter, eighth, etc., sub-pixel offsets) can be varied based on the desired level of complexity.

### Exemplary Complexity Levels

Although not required, it is interesting to note an implementation with varying degrees of complexity combining several of the described features. Table B provides an exemplary five levels of complexity varied by the described features.

TABLE B

| Complex | Number | Point “R” | Sub-pixel | Zero | Ratio |
|---|---|---|---|---|---|
| Level | Seeds “N” | Search | H/Q-Num | Threshold | Threshold |
| 1 | 2 | +/−1 | H-3 | 64 | 0.10 |
| 2 | 4 | +/−1 | H-3 | 32 | 0.10 |
| 3 | 6 | +/−2 | Q-4 | 16 | 0.15 |
| 4 | 8 | +/−2 | Q-8 | 8 | 0.20 |
| 5 | 20 | +/−2 | Q-48 | 4 | 0.25 |

In this example, a complexity level provides various assignments such as feature values to complexity levels. For example, as the complexity increase from a low level of 1 to a high level of 5, the number of lowest SAD seeds (e.g., “N”) increases. Additionally, the number of searches in the original domain increases from R=1 to R=2, and the sub-pixel search starts with low complexity of half-pixel three position searches (e.g. H-3) and ranges up to an exhaustive search in the quarter sub-pixel domain (e.g. Q-48). Finally, the zero motion threshold ranges from a low complexity search where a zero displacement vector is used if the SAD value of the zero displacement block is less than difference value of 48, up to a complex search unless the SAD difference value is 4 or less. Finally, the smaller the value of the ratio threshold the more likely that the number of seeds used in the next level search will be less than N. Values for the parameters shown in Table B may have other combinations, of course. The complexity levels shown in Table B might be exposed to a user as motion estimation scalability settings through the user interface of a video encoder. Moreover, as noted above, values for the parameters shown in Table B (along with other and/or additional parameters) could instead be settable by a user or tool in other ways.

### Alternatives

Having described and illustrated the principles of my invention with reference to illustrated examples, it will be recognized that the examples can be modified in arrangement and detail without departing from such principles. Additionally, as will be apparent to ordinary computer scientists, portions of the examples or complete examples can be combined with other portions of other examples in whole or in part. It should be understood that the programs, processes, or methods described herein are not related or limited to any particular type of computer apparatus, unless indicated otherwise. Various types of general purpose or specialized computer apparatus may be used with or perform operations in accordance with the teachings described herein. Elements of the illustrated embodiment shown in software may be implemented in hardware and vice versa. Techniques from one example can be incorporated into any of the other examples.

In view of the many possible embodiments to which the principles of the invention may be applied, it should be recognized that the details are illustrative only and should not be taken as limiting the scope of my invention. Rather, I claim as my invention all such embodiments as may come within the scope and spirit of the following claims and equivalents thereto.

I claim:

1. A video encoder adapted to perform a method comprising:
performing scalable motion estimation according to values for plural scalability parameters, the plural scalability parameters including two or more of: a first parameter indicating a seed count, a second parameter indicating a zero motion threshold, a third parameter indicating a fitness ratio threshold, a fourth parameter indicating an integer pixel search point count, or a fifth parameter indicating a sub-pixel search point count.

2. The video encoder of claim 1 wherein the values for the plural scalability parameters depend on one or more settings from a user of the video encoder, and wherein the values balance computational complexity and speed of the scalable motion estimation versus quality and/or completeness of the scalable motion estimation.

3. The video encoder of claim 1 wherein the scalable motion estimation includes:
downsampling video data from an original domain to a downsampled domain;
searching a reduced search area in the downsampled domain in order to identify one or more seeds each representing a matching block in the downsampled domain;
upsampling the identified one or more seeds to obtain one or more upsampled seeds in the original domain;
searching one or more blocks at integer pixel offsets in the original domain around the one or more upsampled seeds in order to identify one or more matching blocks at integer pixel offsets in the original domain;
determining a gradient between a closest matching block of the one or more matching blocks in the original domain and a second closest matching block around the closest matching block;
interpolating sub-pixel sample values of the video data; and
searching one or more blocks at sub-pixel offsets along the determined gradient in order to determine a closest matching block at the sub-pixel offsets.

4. The video encoder of claim 3 wherein the downsampling is 4:1 in both the horizontal and vertical dimensions, and wherein the identifying one or more seeds comprises performing a sum of absolute differences between a current video data block in the downsampled domain and a reference video data block in the reduced search area in the downsampled domain.

5. The video encoder of claim 1 wherein for at least one block in a predicted picture, if a comparison indicates that a difference measure at a zero displacement position of a reference picture is less than or equal to the zero motion threshold, then plural other searches are skipped for the at least one block in the predicted picture.

6. The video encoder of claim 1 wherein the scalable motion estimation is performed for one or more blocks, and wherein each of the one or more blocks is a macroblock or part thereof.

7. The video encoder of claim 1 wherein the scalable motion estimation includes evaluating, versus the fitness ratio threshold, a ratio between plural ranked difference measures for plural matching blocks, and wherein the third parameter is variable based on an indicated complexity.

8. The video encoder of claim 1 wherein the scalable motion estimation includes searching plural blocks at integer pixel offsets in a variable-size area, and wherein size of the variable-size area is adjustable according to variable complexity levels as indicated by the fourth parameter.

9. The video encoder of claim 8 wherein the variable-size area comprises integer pixel offsets within one or two pixels of an upsampled seed location.

10. The video encoder of claim 1 wherein the scalable motion estimation includes estimating motion at half-pixel offsets or quarter-pixel offsets depending on a variable complexity level.

11. A video decoder decoding a bit stream created by the video encoder performing scalable motion estimation according to claim 1.

12. The video encoder of claim 1 wherein sub-pixel offsets searched along a gradient are selected based on a predefined sub-pixel pattern associated with a complexity level indicated by the fifth parameter.

13. The video encoder of claim 1 wherein sub-pixel offsets searched along a gradient follow a sub-pixel search configuration associated with the fifth parameter, and wherein the sub-pixel search configuration is,
a three position sub-pixel search in a half-pixel resolution;
a four position sub-pixel search in a quarter-pixel resolution; or
an eight position sub-pixel search in a quarter-pixel resolution.

14. The video encoder of claim 1 wherein sub-pixel offsets searched along a gradient follow a sub-pixel search configuration, wherein the sub-pixel search configuration is,
focused by a horizontal gradient;
focused by a vertical gradient; or
focused by a diagonal gradient.

15. A method of performing motion estimation in video encoding, the method comprising:
comparing reduced blocks of video data in a reduced search area of a downsampled reference picture to a specific reduced block in a downsampled predicted picture and identifying a number of candidate blocks in a downsampled domain;
upsampling indicators for the blocks in the downsampled domain to identify corresponding candidate blocks in an original domain;
comparing blocks at integer offsets around the candidate blocks in the original domain to a specific block in a predicted picture and identifying a closest candidate block among the blocks at integer offsets, and
upon identifying the closest candidate block, identifying a next closest candidate block within one pixel adjacency of the closest candidate block; and
determining a sub-pixel search configuration along a gradient between the closest candidate block and the next closest candidate block, wherein the sub-pixel search configuration is based at least in part on the gradient and a scalable motion estimation complexity level indication.

16. The method of claim 15, further comprising:
interpolating values at sub-pixel offsets in the sub-pixel search configuration; and
comparing blocks at sub-pixel offsets in the sub-pixel search configuration to the specific block in the predicted picture and determining whether any of the blocks at the sub-pixel offsets provide a closer match than the closest candidate block among the blocks at integer offsets.

17. The method of claim 15, wherein the sub-pixel search configuration is focused by a direction of the gradient.

18. A computer readable medium having instructions stored thereon for performing a method of scalable motion estimation, the method comprising:
downsampling video data from an original domain to a downsampled domain;
searching a reduced search area in the downsampled domain in order to identify one or more seeds each representing a candidate blocks in the downsampled domain;
upsampling the identified one or more seeds to obtain one or more upsampled seeds in the original domain;
searching one or more blocks at integer pixel offsets in the original domain around the one or more upsampled seeds in order to identify one or more candidate blocks at integer pixel offsets in the original domain;
determining a gradient between a closest candidate block of the one or more candidate blocks at integer pixel offsets and a second closest candidate block around the closest candidate block;
interpolating sub-pixel sample values of the video data; and
searching one or more blocks at sub-pixel offsets along the determined gradient in order to determine a closest candidate block among the one or more blocks at the sub-pixel offsets.

19. The computer readable medium of claim 18, wherein the one or more seeds identified in the downsampled domain are arranged in order from a closest matching fitness value to a least matching fitness value, and wherein ratios between adjacent fitness values are compared with a ratio threshold value.

20. The computer readable medium of claim 18, wherein the sub-pixel offsets searched along the determined gradient follow a sub-pixel search configuration and wherein the sub-pixel search configuration is,
a three position sub-pixel search in a half-pixel resolution;
a four position sub-pixel search in a quarter-pixel resolution; or
an eight position sub-pixel search in a quarter-pixel resolution.
